(19) United States
(12) Patent Application Publication
(10) Pub. No.: US 2009/0293539 A1
(43) Pub. Date: Dec. 3, 2009

(54) Method And Apparatus For Producing Carbon Monoxide By Cryogenic Distillation

(75) Inventors: Alain Briglia, Corze (FR); Philippe Court, Paris (FR); Natacha Haik-Beraud, Champigny-Sur-Marne (FR); Antoine Hernandez, Le Plessis-Trevise (FR); Christian Monereau, Paris (FR)

Correspondence Address: AIR LIQUIDE;Intellectual Property, 2700 POST OAK BOULEVARD, SUITE 1800, HOUSTON, TX, 77056, US

(73) Assignee: L'Air Liquide Societe Anonyme Pour L'Etude Et L'Explotation Des Procedes Georges Claude, Paris (FR)

(21) Appl. No.: 12/523,036

(22) PCT Filed: Jan. 10, 2008
(86) PCT No.: PCT/FR08/50046

§ 371 Date: Jul. 13, 2009

(30) Foreign Application Priority Data
Jan. 16, 2007 (FR) 0752688

(51) Int. Cl. F25J 3/00; C01B 31/18

(52) U.S. Cl. 62/625; 62/620

(57) ABSTRACT

A method and apparatus for producing carbon monoxide by cryogenic distillation is provided.

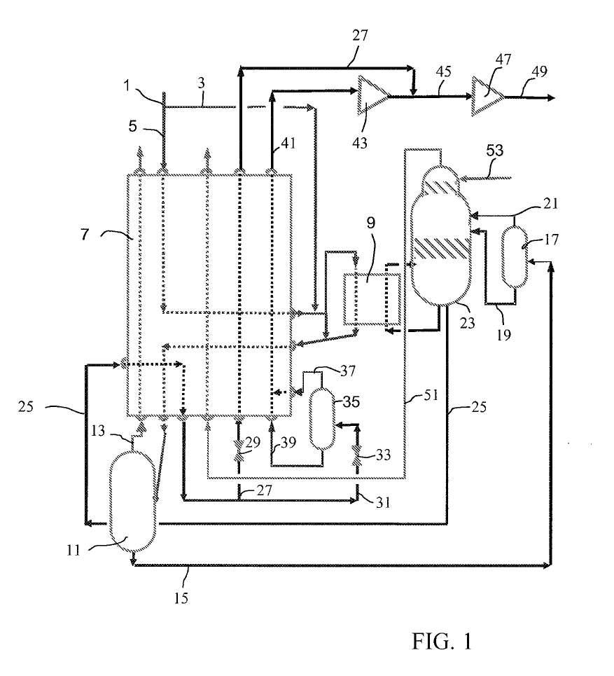

The present invention relates to a method and apparatus for producing carbon monoxide by cryogenic distillation.

The units for producing carbon monoxide and hydrogen may be separated into two parts:

generation of the syngas (mixture containing H₂ CO, CH₄, CO₂, Ar and N₂ essentially). Among the various industrial routes for producing syngas, the one based on coal gasification may present numerous advantages as regards these operating costs and appears to be expanding more and more especially in countries like China. The design of this unit, which comprises a reactor for gasification of coal with oxygen is based on the required productions of carbon monoxide (CO) and hydrogen.

purification of the syngas.

Found therein is:

a unit for scrubbing with a liquid solvent in order to eliminate most of the acid gases contained in the syngas;

a unit for purifying over a bed of absorbents; and

a unit for separating via a cryogenic route known as a cold box for the production of CO.

Generally, the syngas comprises a mixture at high pressure (around 60 bar) and is highly enriched in CO. Another advantage of the coal gasification process is the low content of inert components (CH₄, argon and nitrogen) present in the syngas at the inlet to the cold box for the production of pure CO.

This makes it possible to envisage a relatively simplified flowchart for the cold box, the cryogenic separation being limited to a separation between the CO and hydrogen. The contents of inert components in the syngas are compatible with the CO purity required by the client in most cases.

This flowchart does not comprise a cycle dedicated to the separation.

Hydrogen separated from the CO is required at high pressure in order to be able to use it, either in a PSA unit or in a methanol unit.

It is therefore advantageous to maintain the pressure of hydrogen exiting the cold box.

A portion of the separation energy of said cold box is provided by full expansion between the syngas and the pure CO produced at low pressure, but in most cases this free expansion is not sufficient to complete the refrigeration balance of the unit. A supply of liquid nitrogen is necessary to keep the cold box cold and complete the refrigeration balance.

It is known from U.S. Pat. No. 6,266,976 to send a liquid nitrogen fluid directly into the main exchange line. It is apparently not known to mix liquid nitrogen into the overhead gas of the stripping column. However these two solutions have drawbacks that this invention proposes to improve.

Sending liquid nitrogen to be vaporized directly in the exchange line risks prematurely embrittling the brazed aluminum exchange line if the liquid nitrogen (LIN) stream injected is not constant.

The risks are accentuated during the starting or cooling phases of the apparatus. Sending LIN directly into the exchange line, which would not be cooled, may cause the premature embrittlement of this exchanger.

The injection of LIN directly into the exchange line also has the risk of solidifying the inert components (especially CH₄) present in the CO circuits since this LIN is the coldest fluid.

The mixing of LIN with the stripping (“flash”) gas would have the same drawbacks as mentioned previously. Furthermore, these damaging effects would be accentuated by the two-phase introduction of the overhead gas from the stripping column mixed with the liquid nitrogen in the exchange line since a liquid/gas mixture with a nitrogen-rich liquid phase and hydrogen-rich gas phase would have to be vaporized directly in the exchange line. If the composition of the mixture is not constant, the vaporization temperature of the liquid would not be constant and would lead to temperature fluctuations in the exchanger and therefore to its premature embrittlement.

According to the present invention, it is proposed to inject this extra liquid nitrogen to complete the refrigeration balance of the apparatus into the upper part of the stripping (“flash”) column.

According to one subject of the invention, a method is provided for producing carbon monoxide by cryogenic distillation in which a mixture containing at least carbon monoxide and hydrogen is cooled, partially condensed and sent to a phase separator, the liquid from the phase separator is sent, optionally after a second phase of partial condensation, to a stripping column, a carbon-monoxide-rich liquid is withdrawn from the bottom of the stripping column and an offgas is withdrawn from the top of the stripping column, characterized in that at least one portion of the refrigeration necessary for the method is provided by injection of liquid nitrogen into the stripping column.

According to other optional aspects:

the liquid nitrogen originates from a source outside the installation where the separation of the mixture containing at least carbon monoxide and hydrogen is carried out; and

the liquid nitrogen is sent to a point located at at least one theoretical tray above a feed for the stripping column originating from the phase separator for separating the syngas partial condensation phase.

According to another aspect of the invention, an apparatus is provided for producing carbon monoxide by cryogenic distillation comprising an exchange line in which a mixture containing at least carbon monoxide and hydrogen is cooled, and partially condensed, a phase separator, a stripping column, a line for sending the liquid from the phase separator, optionally after a second partial condensation phase, to the stripping column, a line for withdrawing a carbon-monoxide-rich liquid from the bottom of the stripping column and line for withdrawing an offgas from the top of the stripping column, characterized in that it comprises a line for injecting liquid nitrogen into the stripping column.

According to other optional aspects:

the liquid nitrogen originates from a source outside the installation where the separation of the mixture containing at least carbon monoxide and hydrogen is carried out;

the apparatus comprises a line for sending liquid nitrogen to a point located at at least one theoretical tray above a feed for the stripping column originating from the phase separator for separating the syngas partial condensation phase;

the apparatus does not comprise a turbine;

the liquid nitrogen is sent to the stripping column without being cooled in the exchange line.

The solution has the following two-fold advantage:

a reduction in the risk of embrittlement of the exchange line since the LIN is vaporized directly in the column and the gas produced exits with the overhead gas from the stripping (“flash”) column and therefore a cold gas is sent to the exchange line and not a liquid, the risk of exchanger embrittlement is very greatly reduced during the cooling phases of the apparatus since the injection of LIN would be carried out directly in a column; and

increase in the CO recovery efficiency of the unit since the injection of LIN carries out a nitrogen scrubbing and makes it possible to recover more CO in the liquid phase at the bottom of the stripping (“flash”) column by reducing its losses in the gas phase.

The FIGURE presents a method according to the invention. A stream of syngas 1 is divided into two. One portion 5 at 38° C. is sent to the hot end of an exchange line 7 where it is cooled to an intermediate temperature of −135° C. Cooled to this temperature it is mixed with a stream 3 of syngas which is not cooled in the exchange line and which makes it possible to modify the temperature of the syngas at the inlet to the exchanger 9. It is important to be able to adjust the heat provided to the exchanger 9 in order to regulate the content of hydrogen in the bottoms liquid of the stripping column. One portion of the syngas is cooled further in an exchanger 9 to −148° C. whilst the remainder by-passes the exchanger 9, again for the purpose of regulating the heat to be provided as reboiling for the stripping column in order to regulate the hydrogen content in the bottom of this stripping column. The two reunited streams are then sent back into the exchange line 7 where the mixed stream is cooled to −177° C. Then the partially condensed syngas is sent into a phase separator 11. The overhead gas 13, rich in hydrogen, is heated in the exchange line 7 and serves as product. The bottoms liquid 15 is sent to a second phase separator 17, the liquid stream 19 and the gas stream 21 of which are sent at different levels to the stripping (“flash”) column 23.

Bottoms liquid 25 from the stripping column 23 is subcooled in the exchange line and divided into two. One stream 27 is expanded in a valve 29 then heated in the exchange line 7. Another stream 31 is expanded by a valve 33, then sent to a phase separator 35, the gas 37 and the liquid 39 of which are sent to the exchange line 7 in order to be heated therein after being mixed. The mixed stream 41 constitutes a low-pressure carbon monoxide and is compressed in a compressor 43 before being mixed with the carbon monoxide 27. The stream thus formed 45 is compressed in a compressor 47 and serves as product 49 as high-pressure carbon monoxide.

As a variant, the phase separator may operate as a thermosiphon, which allows a better regulation of the cooling temperature at the cold end of the exchange line 7.

The subcooling of the bottoms liquid from the stripping column is provided by the exchanger 9 heated by the stream of syngas. The liquid is cooled from −168° C. to −177° C.

The overhead gas 51 from the stripping column 23, known as “flash” gas is sent to the cold end of the exchange line where it is heated.

Refrigeration is provided to the installation by injection of liquid nitrogen 53, which originates from an air separation apparatus, an apparatus for purifying natural gas contaminated with nitrogen, another apparatus for producing carbon monoxide, the feed gas of which contains nitrogen or the apparatus itself if the feed gas contains nitrogen and the apparatus comprises a denitrogenation column. The liquid nitrogen injection point is located at at least one theoretical tray above the gaseous feed for the stripping column originating from the phase separator.

1-7. (canceled)

8. A method for producing carbon monoxide by cryogenic distillation from a mixture containing at least carbon monoxide and hydrogen comprising;
a) cooling, partially condensing and sending the mixture to a phase separator,
b) sending the liquid from the phase separator to a stripping column,
c) withdrawing a carbon-monoxide-rich liquid from the bottom of the stripping column and withdrawing an offgas from the top of the stripping column,
wherein at least one portion of the refrigeration necessary for the method is provided by injection of liquid nitrogen into the stripping column.

9. The method of claim 8, wherein the liquid nitrogen originates from a source outside the installation where the separation of the mixture containing at least carbon monoxide and hydrogen is carried out.

10. The method of claim 8, wherein the liquid nitrogen is sent to a point located at at least one theoretical tray above a feed for the stripping column originating from the phase separator for separating the mixture partial condensation phase.

11. An apparatus for producing carbon monoxide by cryogenic distillation comprising;
a) an exchange line in which a mixture containing at least carbon monoxide and hydrogen is cooled, and partially condensed,
b) a phase separator,
c) a stripping column,
d) a line for sending the liquid from the phase separator to the stripping column,
e) a line for withdrawing a carbon-monoxide-rich liquid from the bottom of the stripping column,
f) a line for withdrawing an offgas from the top of the stripping column, and
g) a line for injecting liquid nitrogen into the stripping column.

12. The apparatus of claim 11, wherein the liquid nitrogen originates from a source outside the installation where the separation of the mixture containing at least carbon monoxide and hydrogen is carried out.

13. The apparatus as of claim 11, further comprising a line for sending liquid nitrogen to a point located at at least one theoretical tray above a feed for the stripping column originating from the phase separator for separating the syngas partial condensation phase.

14. The apparatus of claim 11, wherein the liquid nitrogen is sent to the stripping column without being cooled in the exchange line.
